(19) United States
(12) Patent Application Publication
(10) Pub. No.: US 2020/0123429 A1
(43) Pub. Date: Apr. 23, 2020

(54) METHODS FOR TREATING A DRILLING FLUID

(71) Applicant: AES DRILLING FLUIDS, Houston, TX (US)

(72) Inventors: Matthew OFFENBACHER, Houston, TX (US); Richard BAXTER, Katy, TX (US)

(21) Appl. No.: 16/597,980

(22) Filed: Oct. 10, 2019

Related U.S. Application Data
(60) Provisional application No. 62/748,938, filed on Oct. 22, 2018.

(51) Int. Cl. C09K 8/36; C09K 8/54; C09K 8/52; E21B 21/00; E21B 21/06

(52) U.S. Cl. CPC C09K 8/36; C09K 8/54; C09K 8/52; E21B 37/06; E21B 21/062; C09K 2208/32; C09K 2208/34; E21B 21/003

(57) ABSTRACT

Embodiments described herein generally relate to drilling fluids and more specifically relate to methods for treating drilling fluids. A method for treating a drilling fluid within a wellbore includes preparing a treatment fluid at an off-site location, where the treatment fluid contains at least a base fluid, an emulsifier, and a wetting agent. The method also includes transporting the treatment fluid from the off-site location to a drilling site containing the wellbore and adding the treatment fluid into the wellbore to combine with the drilling fluid and produce a treated drilling fluid.

### CROSS-REFERENCE TO RELATED APPLICATIONS

This application claims benefit to U.S. Appl. No. 62/748,938, filed on Oct. 22, 2018, which is herein incorporated by reference.

### BACKGROUND

### Field

Embodiments described herein generally relate to drilling fluids, and more specifically relate to methods for treating drilling fluids.

### Description of the Related Art

Invert emulsion drilling fluids are used throughout the drilling industry due to their superior performance over conventional emulsions (e.g., water-continuous emulsions). Drilling fluids perform numerous functions, including controlling downhole pressures, removing drill cuttings, and lubricating the drilling assembly. Invert emulsions are a mixture of chemicals, featuring an oil-based continuous phase and an aqueous-based non-continuous phase. The oil-based continuous phase may include a variety and/or mixture of non-aqueous fluids and the aqueous-based non-continuous phase may include water, brine, alcohol, and/or some other aqueous fluid. The emulsion maybe stabilized through surfactant chemistry.

During a drilling process, the drilling fluid is circulated down a drill pipe and through a drill bit, and up the annulus of the hole to surface. The drilling fluid carries drill cuttings which are typically separated from the drilling fluid using solids control equipment, such as shakers and centrifuges and returned to the circulating pit. Some the drilling fluid is lost on the cuttings and some fine solids remain in the system. The drilling fluid continues to be circulated throughout the drilling process. Properties of the drilling fluid are altered during the drilling process by the accumulation of fine solids, introduction of formation materials, separation of desired solids such as weighting material, and depletion of chemical additives such as emulsifiers and wetting agents.

Chemical additives may be added to the drilling fluid in order to maintain the desired properties of the drilling fluid or to refresh a depleted drilling fluid. These chemical additives are typically maintained in large quantities at the drill site for both regular treatment and contingency. This results in excess waste of the chemical additives and increased risk of spillage of and/or environmental contact by the chemical additives. The inclusion of the chemical additive also requires additional transportation and handling. In applications that include cold weather environments, some chemical additives become too thick to pour. These chemical additives may be placed on dry carriers, such as silica, as a pourable powder in order to be added to the drilling fluid or the chemicals may be diluted. The use of dry carriers is cumbersome and can add expense and loss of time when administering these chemical additives. Liquid diluents are expensive and increase the volume of product required to treat the drilling fluid.

Therefore, there is a need for improved methods to treat a drilling fluid which is downhole in a wellbore.

### SUMMARY

Embodiments described herein generally relate to drilling fluids, and more specifically relate to methods for treating a drilling fluid. In one or more embodiments, a method for treating a drilling fluid within a wellbore includes preparing a treatment fluid at an off-site location, where the treatment fluid contains at least a base fluid, an emulsifier, and a wetting agent. The method also includes transporting the treatment fluid from the off-site location to a drilling site containing the wellbore and adding the treatment fluid into the wellbore to combine with the drilling fluid and produce a treated drilling fluid.

In some embodiments, a method for treating a drilling fluid within a wellbore includes preparing a treatment fluid at an off-site location. The treatment fluid contains at least 85 v/v % of a base fluid, about 0.2 v/v % to about 15 v/v % of a emulsifier; and about 0.2 v/v % to about 15 v/v % of a wetting agent. The base fluid contains one or more organic solvents or fluids, such as, diesel oil, kerosene, biodiesel, fuel oil, mineral oil, synthetic oil, crude oil, vegetable oil, fatty acid, olefin, organic ester, linear paraffin, branched paraffin, acetal, salts thereof, or any combination thereof. The method also includes transporting the treatment fluid from the off-site location to a drilling site containing the wellbore and adding the treatment fluid into the wellbore to combine with the drilling fluid and produce a treated drilling fluid.

In other embodiments, a method for treating a drilling fluid within a wellbore includes combining and mixing a base fluid, an emulsifier, and a wetting agent with a pump at an off-site location to prepare a treatment fluid and transporting the treatment fluid a portable container from the off-site location to a drilling site containing the wellbore. The method also includes adding the treatment fluid at a rate from about 800 L/hr to about 13,000 L/hr into the wellbore to combine with the drilling fluid.

### BRIEF DESCRIPTION OF THE DRAWINGS

So that the manner in which the above recited features of the disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of scope, for the disclosure may admit to other equally effective implementations.

FIG. 1 depicts a schematic of an off-site location containing a facility for producing a treatment fluid and a schematic of a drilling site containing a wellbore drilling assembly, according to one or more embodiments described herein.

To facilitate understanding, identical reference numerals have been used, where possible, to designate identical elements that are common to the Figures. It is contemplated that elements and features of one implementation may be beneficially incorporated in other implementations without further recitation.

### DETAILED DESCRIPTION

Embodiments described herein generally relate to drilling fluids, and more specifically relate to methods for treating a drilling fluid. A method for treating a drilling fluid within or outside of a wellbore can include preparing a treatment fluid at an off-site location, transporting the treatment fluid from the off-site location to a drilling site containing the wellbore, and adding the treatment fluid into the wellbore to combine with the drilling fluid and produce a treated drilling fluid. In some examples, the treatment fluid is introduced into the wellbore and directly added to the drilling fluid therein. In other examples, the drilling fluid or portions thereof can be brought out of the wellbore, combined with the treatment fluid to produce the treated drilling fluid, and then the treated drilling fluid is introduced into the wellbore.

The drilling fluid and the treated drilling fluid are an invert emulsion (e.g., a water-in-oil emulsion). As such, the drilling fluid and the treated drilling fluid have an aqueous-based non-continuous phase within an oil-based continuous phase. The treatment fluid is an additive package for the drilling fluid depleted of components and/or additives. The treatment fluid contains one or more base fluids (e.g., an organic or oil-based fluid), one or more emulsifiers, one or more wetting agents, and optionally, one or more other additives. The treatment fluid can be combined and mixed with the drilling fluid at any time of the drilling operation. The treatment fluid can be combined and mixed with the drilling fluid before, during, and/or after actively drilling the wellbore with the drill. For example, the treatment fluid is added to the drilling fluid within the wellbore while continuously drilling the wellbore.

The base fluid contains one or more organic compounds, organic fluids, or organic solvents, and/or other organic components. Exemplary organic components can be or include one or more of diesel oil, kerosene, biodiesel, fuel oil, mineral oil, synthetic oil, crude oil, vegetable oils, fatty acids, olefins, organic esters, linear paraffins, branched paraffins, acetals (e.g., polyacetal compounds or materials), salts thereof, or any combination thereof.

In some examples, the treatment fluid contains at least 50 v/v %, at least 60 v/v %, at least 70 v/v %, at least 80 v/v %, at least 85 v/v %, at least 90 v/v %, at least 92 v/v %, at least 94 v/v %, at least 95 v/v %, at least 97 v/v %, at least 98 v/v %, or at least 99 v/v % of the base fluid. In other examples, the treatment fluid contains about 70 v/v %, about 75 v/v %, about 80 v/v %, or about 85 v/v % to about 87 v/v %, about 90 v/v %, about 92 v/v %, about 94 v/v %, about 95 v/v %, about 97 v/v %, about 98 v/v %, or about 99 v/v % of the base fluid. For example, the treatment fluid contains from at least 85 v/v %, at least 90 v/v %, or at least 94 v/v % to about 95 v/v %, about 97 v/v %, about 98 v/v %, or about 99 v/v % of the base fluid.

The emulsifier contains one or more emulsifying agents. Exemplary emulsifying agents can be or include one or more of polyamides, amido amines, carboxylic acids, esters or ethers of one or more carboxylic acids, fatty acids, esters or ethers of one or more fatty acids, salts thereof, or any combination thereof. In some examples, the emulsifier contains one or more tall oil fatty acids, esters or ethers of fatty acids of tall oil fatty acids, salts thereof, or any combination thereof. Examples of commercial emulsifiers can be or include ABS MUL and AES MUL X emulsifiers, commercially available from AES Drilling Fluids, LLC. The emulsifier has a hydrophilic:lipophilic balance (HLB) of about 7, about 7.5, about 8, about 8.5, about 9, about 9.5, about 10, about 10.5, about 11, or about 12. For example, the emulsifier has an HLB ranging from about 7 to about 12, about 7 to about 11, about 7 to about 10, about 7 to about 9.5, about 7 to about 9, about 8 to about 12, about 8 to about 11, about 8 to about 10, about 8 to about 9.5, or about 8 to about 9.

The treatment fluid contains about 0.1 v/v %, about 0.2 v/v %, about 0.5 v/v %, about 0.8 v/v %, about 1 v/v %, about 1.2 v/v %, about 1.5 v/v %, about 1.8 v/v %, or about 2 v/v % to about 2.5 v/v %, about 3 v/v %, about 3.5 v/v %, about 4 v/v %, about 5 v/v %, about 7 v/v %, about 10 v/v %, about 12 v/v %, about 15 v/v %, about 18 v/v %, about 20 v/v %, or about 25 v/v % of the emulsifier. For example, the treatment fluid contains about 0.1 v/v % to about 25 v/v %, about 0.2 v/v % to about 25 v/v %, about 0.2 v/v % to about 20 v/v %, about 0.2 v/v % to about 18 v/v %, about 0.2 v/v % to about 15 v/v %, about 0.2 v/v % to about 12 v/v %, about 0.2 v/v % to about 10 v/v %, about 0.2 v/v % to about 8 v/v %, about 0.2 v/v % to about 5 v/v %, about 0.2 v/v % to about 3 v/v %, about 0.2 v/v % to about 1 v/v %, about 1 v/v % to about 25 v/v %, about 1 v/v % to about 20 v/v %, about 1 v/v % to about 18 v/v %, about 1 v/v % to about 15 v/v %, about 1 v/v % to about 12 v/v %, about 1 v/v % to about 10 v/v %, about 1 v/v % to about 8 v/v %, about 1 v/v % to about 5 v/v %, about 1 v/v % to about 3 v/v %, about 1 v/v % to about 1 v/v %, about 1.2 v/v % to about 25 v/v %, about 1.2 v/v % to about 20 v/v %, about 1.2 v/v % to about 18 v/v %, about 1.2 v/v % to about 15 v/v %, about 1.2 v/v % to about 12 v/v %, about 1.2 v/v % to about 10 v/v %, about 1.2 v/v % to about 8 v/v %, about 1.2 v/v % to about 5 v/v %, about 1.2 v/v % to about 3 v/v %, about 1.2 v/v % to about 1.5 v/v %, about 1.5 v/v % to about 25 v/v %, about 1.5 v/v % to about 20 v/v %, about 1.5 v/v % to about 18 v/v %, about 1.5 v/v % to about 15 v/v %, about 1.5 v/v % to about 12 v/v %, about 1.5 v/v % to about 10 v/v %, about 1.5 v/v % to about 8 v/v %, about 1.5 v/v % to about 5 v/v %, about 1.5 v/v % to about 3 v/v %, or about 1.5 v/v % to about 2 v/v % of the emulsifier.

The wetting agent can be or include one or more anionic wetting agents, cationic wetting agents, amphoteric wetting agents, nonionic wetting agents, or any combination thereof. In some examples, the wetting agent contains one or more of lecithins, imidazolines, tall oil fatty acids or ester anhydrides, sulfonic acid derivatives of tall oil fatty acid, derivatives thereof, salts thereof, or any combination thereof. In one or more examples, a fatty acid or ester anhydride is reacted with an amino sulfonic acid salt, such as an organic alkyl or aryl salt or sulfamic acid salt, to produce a wetting agent. The resulting wetting agent product can be one or more sulfonic acid salts which include salts of taurine, N-methyl taurine, aminomethanesulfonic acid, 2-aminobenzenesulfonic acid, sulfanilic acid, sulfamic acid, salts thereof, esters thereof, derivatives thereof, or any combination thereof.

Exemplary of commercially available wetting agents can be or include AES WA II and AES WAX surfactants, commercially available from AES Drilling Fluids, LLC. The wetting agent has a hydrophilic:lipophilic balance (HLB) of about 6, about 6.5, about 7, or about 7.5 to about 8, about 8.5, about 9, about 9.5, about 10, about 11, about 12, about 13, or about 14. For example, the wetting agent has an HLB ranging from about 6 to about 14, about 6 to about 12, about 6 to about 10, about 6 to about 9, about 6 to about 8, about 7 to about 10, about 7 to about 9, or about 11 to about 14.

The treatment fluid contains about 0.1 v/v %, about 0.2 v/v %, about 0.5 v/v %, about 0.8 v/v %, about 1 v/v %, about 1.2 v/v %, about 1.5 v/v %, about 1.8 v/v %, or about 2 v/v % to about 2.5 v/v %, about 3 v/v %, about 3.5 v/v %, about 4 v/v %, about 5 v/v %, about 7 v/v %, about 10 v/v %, about 12 v/v %, about 15 v/v %, about 18 v/v %, about 20 v/v %, or about 25 v/v % of the wetting agent. For example, the treatment fluid contains about 0.1 v/v % to about 25 v/v %, about 0.2 v/v % to about 25 v/v %, about 0.2 v/v % to about 20 v/v %, about 0.2 v/v % to about 18 v/v %, about 0.2 v/v % to about 15 v/v %, about 0.2 v/v % to about 12 v/v %, about 0.2 v/v % to about 10 v/v %, about 0.2 v/v % to about 8 v/v %, about 0.2 v/v % to about 5 v/v %, about 0.2 v/v % to about 3 v/v %, about 0.2 v/v % to about 1 v/v %, about 1 v/v % to about 25 v/v %, about 1 v/v % to about 20 v/v %, about 1 v/v % to about 18 v/v %, about 1 v/v % to about 15 v/v %, about 1 v/v % to about 12 v/v %, about 1 v/v % to about 10 v/v %, about 1 v/v % to about 8 v/v %, about 1 v/v % to about 5 v/v %, about 1 v/v % to about 3 v/v %, about 1 v/v % to about 1 v/v %, about 1.2 v/v % to about 25 v/v %, about 1.2 v/v % to about 20 v/v %, about 1.2 v/v % to about 18 v/v %, about 1.2 v/v % to about 15 v/v %, about 1.2 v/v % to about 12 v/v %, about 1.2 v/v % to about 10 v/v %, about 1.2 v/v % to about 8 v/v %, about 1.2 v/v % to about 5 v/v %, about 1.2 v/v % to about 3 v/v %, about 1.2 v/v % to about 1.5 v/v %, about 1.5 v/v % to about 25 v/v %, about 1.5 v/v % to about 20 v/v %, about 1.5 v/v % to about 18 v/v %, about 1.5 v/v % to about 15 v/v %, about 1.5 v/v % to about 12 v/v %, about 1.5 v/v % to about 10 v/v %, about 1.5 v/v % to about 8 v/v %, about 1.5 v/v % to about 5 v/v %, about 1.5 v/v % to about 3 v/v %, or about 1.5 v/v % to about 2 v/v % of the wetting agent.

In one or more examples, the treatment fluid contains at least 85 v/v % of the base fluid, about 0.2 v/v % to about 15 v/v % of the emulsifier, and about 0.2 v/v % to about 15 v/v % of the wetting agent. In some examples, the treatment fluid contains at least 90 v/v % of the base fluid, about 1.2 v/v % to about 5 v/v % of the emulsifier, and about 1.2 v/v % to about 5 v/v % of the wetting agent. In other examples, the treatment fluid contains at least 94 v/v % of the base fluid, about 1.5 v/v % to about 3 v/v % of the emulsifier, and about 1.5 v/v % to about 3 v/v % of the wetting agent.

In one or more embodiments, the treatment fluid can also include one or more additives or other components. Exemplary additives or components can be or include fluid loss agents (or loss prevention materials), weighting materials, rheological modifiers, viscosifiers, lubricant agents, thinners, filtration control additives, pH adjusting agents (e.g., acids or bases), lime, corrosion inhibitors, scale inhibitors, salts or brines, or any combination thereof.

The treatment fluid contains about 0.1 v/v %, about 0.2 v/v %, about 0.5 v/v %, about 0.8 v/v %, about 1 v/v %, about 1.2 v/v %, about 1.5 v/v %, about 1.8 v/v %, or about 2 v/v % to about 2.5 v/v %, about 3 v/v %, about 3.5 v/v %, about 4 v/v %, about 5 v/v %, about 7 v/v %, about 10 v/v %, about 12 v/v %, about 15 v/v %, about 18 v/v %, about 20 v/v %, or about 25 v/v % of the additive. For example, the treatment fluid contains about 0.1 v/v % to about 25 v/v %, about 0.2 v/v % to about 25 v/v %, about 0.2 v/v % to about 20 v/v %, about 0.2 v/v % to about 18 v/v %, about 0.2 v/v % to about 15 v/v %, about 0.2 v/v % to about 12 v/v %, about 0.2 v/v % to about 10 v/v %, about 0.2 v/v % to about 8 v/v %, about 0.2 v/v % to about 5 v/v %, about 0.2 v/v % to about 3 v/v %, about 0.2 v/v % to about 1 v/v %, about 1 v/v % to about 25 v/v %, about 1 v/v % to about 20 v/v %, about 1 v/v % to about 18 v/v %, about 1 v/v % to about 15 v/v %, about 1 v/v % to about 12 v/v %, about 1 v/v % to about 10 v/v %, about 1 v/v % to about 8 v/v %, about 1 v/v % to about 5 v/v %, about 1 v/v % to about 3 v/v %, about 1 v/v % to about 1 v/v %, about 1.2 v/v % to about 25 v/v %, about 1.2 v/v % to about 20 v/v %, about 1.2 v/v % to about 18 v/v %, about 1.2 v/v % to about 15 v/v %, about 1.2 v/v % to about 12 v/v %, about 1.2 v/v % to about 10 v/v %, about 1.2 v/v % to about 8 v/v %, about 1.2 v/v % to about 5 v/v %, about 1.2 v/v % to about 3 v/v %, about 1.2 v/v % to about 1.5 v/v %, about 1.5 v/v % to about 25 v/v %, about 1.5 v/v % to about 20 v/v %, about 1.5 v/v % to about 18 v/v %, about 1.5 v/v % to about 15 v/v %, about 1.5 v/v % to about 12 v/v %, about 1.5 v/v % to about 10 v/v %, about 1.5 v/v % to about 8 v/v %, about 1.5 v/v % to about 5 v/v %, about 1.5 v/v % to about 3 v/v %, or about 1.5 v/v % to about 2 v/v % of the additive.

The treatment fluid can be prepared by combining and mixing the components at an off-site location. An “off-site location” is used herein to mean at a location other than the drilling site, where the drilling site contains the wellbore in which the treatment fluid is to used or administered (e.g., combined with the drilling fluid within the wellbore). The treatment fluid is transported from the off-site location to the drilling site. For example, the base fluid, the emulsifier, the wetting agent, optionally, one or more additives, and/or one or more other components can be combined and mixed with a mixing system at the off-site location. The mixing system can be or include one or more pumps, one or more nozzles, or any combination thereof. In one or more examples, the mixing system can be or include one or more shearing pumps, one or more centrifugal pumps, one or more spray nozzles, one or more eductor nozzles, or any combination thereof.

In one or more embodiments, the treatment fluid is transported in one or more portable containers from the off-site location to the drilling site. The portable container containing the treatment fluid can be transported by one or more vehicles, such as a truck, a railcar, a marine vessel (e.g., ship, boat, or barge), or any combination thereof. In one or more examples, the portable container can be one or more hoppers, vessels, tanks, drums, bins, intermediate bulk containers (IBCs), totes, a tanker trailer, tanker train car, a railcar, a compartment on a marine vessel, or other types of containers.

In one or more embodiments, the treatment fluid is added to the wellbore and/or the drilling fluid within the wellbore at a rate of about 100 liters per hour (L/hr), about 200 L/hr, about 300 L/hr, about 500 L/hr, about 700 L/hr, about 800 L/hr, about 1,000 L/hr, about 1,200 L/hr, or about 1,500 L/hr to about 1,800 L/hr, about 2,000 L/hr, about 3,000 L/hr, about 5,000 L/hr, about 8,000 L/hr, about 10,000 L/hr, about 13,000 L/hr, about 15,000 L/hr, about 18,000 L/hr, about 20,000 L/hr, or about 25,000 L/hr. For example, the treatment fluid is added to the wellbore and/or the drilling fluid within the wellbore at a rate from about 100 L/hr to about 30,000 L/hr, about 100 L/hr to about 25,000 L/hr, about 100 L/hr to about 20,000 L/hr, about 100 L/hr to about 15,000 L/hr, about 100 L/hr to about 13,000 L/hr, about 100 L/hr to about 10,000 L/hr, about 100 L/hr to about 8,000 L/hr, about 100 L/hr to about 5,000 L/hr, about 100 L/hr to about 3,000 L/hr, about 100 L/hr to about 1,000 L/hr, about 500 L/hr to about 30,000 L/hr, about 500 L/hr to about 25,000 L/hr, about 500 L/hr to about 20,000 L/hr, about 500 L/hr to about 15,000 L/hr, about 500 L/hr to about 13,000 L/hr, about 500 L/hr to about 10,000 L/hr, about 500 L/hr to about 8,000 L/hr, about 500 L/hr to about 5,000 L/hr, about 500 L/hr to about 3,000 L/hr, about 500 L/hr to about 1,000 L/hr, about 800 L/hr to about 30,000 L/hr, about 800 L/hr to about 25,000 L/hr, about 800 L/hr to about 20,000 L/hr, about 800 L/hr to about 15,000 L/hr, about 800 L/hr to about 13,000 L/hr, about 800 L/hr to about 10,000 L/hr, about 800 L/hr to about 8,000 L/hr, about 800 L/hr to about 5,000 L/hr, about 800 L/hr to about 3,000 L/hr, about 800 L/hr to about 1,000 L/hr, about 1,200 L/hr to about 30,000 L/hr, about 1,200 L/hr to about 25,000 L/hr, about 1,200 L/hr to about 20,000 L/hr, about 1,200 L/hr to about 15,000 L/hr, about 1,200 L/hr to about 13,000 L/hr, about 1,200 L/hr to about 10,000 L/hr, about 1,200 L/hr to about 8,000 L/hr, about 1,200 L/hr to about 5,000 L/hr, about 1,200 L/hr to about 3,000 L/hr, or about 1,200 L/hr to about 2,000 L/hr.

The treated drilling fluid contains about 0.1 v/v %, about 0.5 v/v %, about 1 v/v %, about 2 v/v %, about 3 v/v %, about 5 v/v %, about 7 v/v %, about 10 v/v %, about 12 v/v %, or about 15 v/v % to about 18 v/v %, about 20 v/v %, about 25 v/v %, about 30 v/v %, about 40 v/v %, about 50 v/v %, about 60 v/v %, about 70 v/v %, about 80 v/v %, about 90 v/v %, about 95 v/v %, or more of the treatment fluid. For example, the treated drilling fluid contains about 0.1 v/v % to about 95 v/v %, about 0.1 v/v % to about 90 v/v %, about 0.1 v/v % to about 80 v/v %, about 0.1 v/v % to about 70 v/v %, about 0.1 v/v % to about 50 v/v %, about 0.1 v/v % to about 30 v/v %, about 0.1 v/v % to about 20 v/v %, about 1 v/v % to about 95 v/v %, about 1 v/v % to about 90 v/v %, about 1 v/v % to about 80 v/v %, about 1 v/v % to about 70 v/v %, about 1 v/v % to about 50 v/v %, about 1 v/v % to about 30 v/v %, about 1 v/v % to about 20 v/v %, about 10 v/v % to about 95 v/v %, about 10 v/v % to about 90 v/v %, about 10 v/v % to about 80 v/v %, about 10 v/v % to about 70 v/v %, about 10 v/v % to about 50 v/v %, about 10 v/v % to about 30 v/v %, about 10 v/v % to about 20 v/v %, about 30 v/v % to about 95 v/v %, about 30 v/v % to about 90 v/v %, about 30 v/v % to about 80 v/v %, about 30 v/v % to about 70 v/v %, about 30 v/v % to about 50 v/v %, or about 30 v/v % to about 40 v/v % of the treatment fluid. The remainder of the treated drilling fluid can be the drilling fluid within the wellbore.

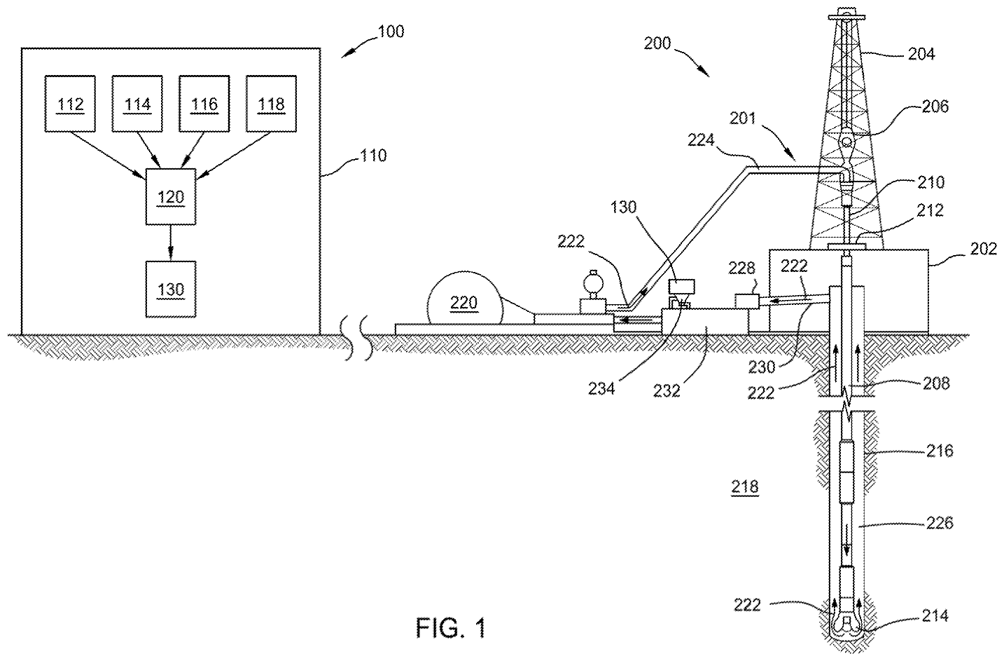

FIG. 1 depicts a schematic of an off-site location 100 containing a facility 110 for producing a treatment fluid and a schematic of a drilling site 200 containing a wellbore drilling assembly 201. The treatment fluid can be prepared by combining and mixing the components in the facility 110 at the off-site location 100. The treatment fluid is transported from the off-site location 100 to the drilling site 200 which are separated by a large enough distance to utilize one or more vehicles (e.g., truck, railcar, marine vessel) for transporting the treatment fluid.

The distance between the off-site location 100 and the drilling site 200 can be, but is not limited to, about 1 kilometer (km), about 5 km, about 10 km, about 25 km, or about 50 km to about 75 km, about 100 km, about 200 km, about 300 km, about 500 km, about 750 km, about 1,000 km, about 2,000 km, about 5,000 km, about 10,000 km, or greater. For example, the distance between the off-site location 100 and the drilling site 200 can be about 1 km to about 10,000 km, about 1 km to about 5,000 km, about 1 km to about 3,000 km, about 1 km to about 2,000 km, about 1 km to about 1,000 km, about 1 km to about 800 km, about 1 km to about 500 km, about 1 km to about 300 km, about 1 km to about 150 km, about 1 km to about 100 km, about 1 km to about 50 km, about 10 km to about 10,000 km, about 10 km to about 5,000 km, about 10 km to about 3,000 km, about 10 km to about 2,000 km, about 10 km to about 1,000 km, about 10 km to about 800 km, about 10 km to about 500 km, about 10 km to about 300 km, about 10 km to about 150 km, about 10 km to about 100 km, about 10 km to about 50 km, about 100 km to about 10,000 km, about 100 km to about 5,000 km, about 100 km to about 3,000 km, about 100 km to about 2,000 km, about 100 km to about 1,000 km, about 100 km to about 800 km, about 100 km to about 500 km, about 100 km to about 300 km, or about 100 km to about 150 km.

The facility 110 for producing the treatment fluid can be or include one or more building or other structures for combining and mixing the components of the treatment fluid. The facility 110 can include one or more sources 112 of a base fluid and/or components thereof, one or more sources 114 of an emulsifier and/or components thereof, one or more sources 116 of a wetting agent and/or components thereof, and one or more sources 118 of an additive and/or components thereof. The sources 112, 114, 116, 118 can be or include vessels or containers and/or delivery or fluid lines which contain the components of the treatment fluid. The base fluid, the emulsifier, the wetting agent, optionally, one or more additives, and/or one or more other components can be transferred from the sources 112, 114, 116, 118 to one or more mixing systems 120 where the components are combined and mixed therein.

The mixing system 120 can be or include one or more containers or vessels, one or more pumps (e.g., shearing pumps or centrifugal pumps), one or more nozzles (e.g., spray nozzle or eductor nozzle), one or more conduits or pipes, one or more valves, or any combination thereof. The components of the treatment fluid can be combined and mixed in-line and/or in a container or vessel as part of the mixing system 120. One or more containers 130 or other vessels are used to contain or store the treatment fluid and/or used to transport the treatment fluid, such as to the drilling site 200.

In one or more embodiments, the treatment fluid disclosed herein can directly or indirectly affect the drilling fluid and/or one or more components or pieces of equipment associated with the preparation, delivery, recapture, recycling, reuse, and/or disposal of the treatment fluid. For example, and with reference to FIG. 1, the treatment fluid can directly or indirectly affect the drilling fluid and/or one or more components or pieces of equipment associated with an exemplary wellbore drilling assembly 201, according to one or more embodiments. It should be noted that while the wellbore drilling assembly 201 is generally depicted as a land-based drilling assembly, those skilled in the art will readily recognize that the principles described herein are equally applicable to off-shore or subsea drilling operations that employ floating or sea-based platforms and rigs, without departing from the scope of the disclosure.

As illustrated, the drilling assembly 201 includes a drilling platform 202 that supports a derrick 204 having a traveling block 206 for raising and lowering a drill string 208. The drill string 208 includes drill pipe and coiled tubing. A kelly 210 supports the drill string 208 as it is lowered through a rotary table 212. A drill bit 214 is attached to the distal end of the drill string 208 and is driven either by a downhole motor and/or via rotation of the drill string 208 from the well surface. As the bit 214 rotates, the bit 214 produces a wellbore 216 that penetrates various subterranean formations 218.

One or more pumps 220 (e.g., a mud pump) circulates drilling fluid 222 through a feed pipe 224 and to the kelly 210, which conveys the drilling fluid 222 downhole through the interior of the drill string 208 and through one or more orifices in the drill bit 214. The drilling fluid 222 is then circulated back to the surface via an annulus 226 defined between the drill string 208 and the walls of the wellbore 216. At the surface, the recirculated or spent drilling fluid 222 exits the annulus 226 and can be conveyed to one or more fluid processing units 228 via an interconnecting flow line 230. After passing through the fluid processing unit 228, a “cleaned” drilling fluid 222 is deposited into a nearby retention pit 232 (e.g., a mud pit). While illustrated as being arranged at the outlet of the wellbore 216 via the annulus 226, those skilled in the art will readily appreciate that the fluid processing unit 228 can be arranged at any other location in the drilling assembly 201 to facilitate proper function, without departing from the scope of the disclosure.

The treatment fluid disposed in the container 180 can be added to the drilling fluid 222 via a mixing hopper 234 communicably coupled to or otherwise in fluid communication with the retention pit 232. The mixing hopper 234 can include mixers and related mixing equipment. In other embodiments, however, the treatment fluid can be added to the drilling fluid 222 at any other location in the drilling assembly 201. In one or more embodiments, for example, there could be more than one retention pit 232, such as multiple retention pits 232 in series. Moreover, the retention pit 232 can be representative of one or more fluid storage facilities and/or units where the treatment fluid can be stored, reconditioned, and/or regulated until added to the drilling fluid 222. In other examples, the treatment fluid is introduced or otherwise added into the wellbore 216 to combine with the drilling fluid 222 and produce a treated drilling fluid.

The treatment fluid can directly or indirectly affect the drilling fluid 222 and/or any of the components and/or equipment of the drilling assembly 201. For example, the treatment fluid can replenish additive in the drilling fluid 222 that has been depleted while circulating through the drill string 208, the drill bit 214, and/or the wellbore 216. The treatment fluid combined with the drilling fluid produces a treated drilling fluid.

In some examples, the treatment fluid and/or the treated drilling fluid can directly or indirectly affect the fluid processing unit 228, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit 228 can further include one or more sensors, gauges, pumps, compressors, and the like used to store, monitor, regulate, and/or recondition the drilling fluid.

The treatment fluid and/or the treated drilling fluid can directly or indirectly affect the pump 220, which representatively includes any conduits, pipelines, trucks, tubulars, and/or pipes used to fluidically convey the treatment fluid to the subterranean formation, any pumps, compressors, or motors (e.g., topside or downhole) used to drive the diverter composition into motion, any valves or related joints used to regulate the pressure or flow rate of the diverter composition, and any sensors (e.g., pressure, temperature, flow rate, and the like), gauges, and/or combinations thereof, and the like. The treatment fluid and/or the treated drilling fluid can also directly or indirectly affect the mixing hopper 234 and the retention pit 232 and their assorted variations.

The treatment fluid and/or the treated drilling fluid can also directly or indirectly affect the various downhole or subterranean equipment and tools that can come into contact with the treatment fluid and/or the treated drilling fluid such as the drill string 208, any floats, drill collars, mud motors, downhole motors, and/or pumps associated with the drill string 208, and any measurement while drilling (MWD)/logging while drilling (LWD) tools and related telemetry equipment, sensors, or distributed sensors associated with the drill string 208. The treatment fluid and/or the treated drilling fluid can also directly or indirectly affect any downhole heat exchangers, valves and corresponding actuation devices, tool seals, packers and other wellbore isolation devices or components, and the like associated with the wellbore 216. The treatment fluid and/or the treated drilling fluid can also directly or indirectly affect the drill bit 214, which can include roller cone bits, polycrystalline diamond compact (PDC) bits, natural diamond bits, any hole openers, reamers, coring bits, and the like.

While not specifically illustrated herein, the treatment fluid and/or the treated drilling fluid can also directly or indirectly affect any transport or delivery equipment used to convey the treatment fluid to the drilling assembly 201 such as, for example, any transport vessels, conduits, pipelines, trucks, tubulars, and/or pipes used to fluidically move the treatment fluid and/or the treated drilling fluid from one location to another, any pumps, compressors, or motors used to drive the diverter composition into motion, any valves or related joints used to regulate the pressure or flow rate of the diverter composition, and any sensors (e.g., pressure and temperature), gauges, and/or combinations thereof, and the like.

Embodiments of the present disclosure further relate to any one or more of the following paragraphs 1-23:

1. A method for treating a drilling fluid within a wellbore, comprising: preparing a treatment fluid at an off-site location, wherein the treatment fluid comprises a base fluid, an emulsifier, and a wetting agent; transporting the treatment fluid from the off-site location to a drilling site containing the wellbore; and adding the treatment fluid into the wellbore to combine with the drilling fluid and produce a treated drilling fluid.

2. A method for treating a drilling fluid within a wellbore, comprising: preparing a treatment fluid at an off-site location, wherein the treatment fluid comprises: at least 85 v/v % of a base fluid, wherein the base fluid comprises diesel oil, kerosene, biodiesel, fuel oil, mineral oil, synthetic oil, crude oil, a vegetable oil, a fatty acid, an olefin, an organic ester, a linear paraffin, a branched paraffin, an acetal, salts thereof, or any combination thereof; about 0.2 v/v % to about 15 v/v % of a emulsifier; and about 0.2 v/v % to about 15 v/v % of a wetting agent; transporting the treatment fluid from the off-site location to a drilling site containing the wellbore; and adding the treatment fluid into the wellbore to combine with the drilling fluid.

3. A method for treating a drilling fluid within a wellbore, comprising: combining and mixing a base fluid, an emulsifier, and a wetting agent with a pump at an off-site location to prepare a treatment fluid; transporting the treatment fluid a portable container from the off-site location to a drilling site containing the wellbore; and adding the treatment fluid at a rate from about 800 L/hr to about 13,000 L/hr into the wellbore to combine with the drilling fluid.

4. The method according to any one of paragraphs 1-3, wherein the treatment fluid is added to the wellbore while continuously drilling the wellbore.

5. The method according to any one of paragraphs 1-4, wherein the treatment fluid is added to the wellbore at a rate from about 800 L/hr to about 13,000 L/hr.

6. The method according to any one of paragraphs 1-5, wherein the treatment fluid is added to the wellbore at a rate from about 1,200 L/hr to about 8,000 L/hr.

7. The method according to any one of paragraphs 1-6, wherein the treated drilling fluid comprises about 0.1 v/v % to about 90 v/v % of the treatment fluid.

8. The method according to any one of paragraphs 1-7, wherein the treatment fluid comprises: at least 85 v/v % of the base fluid; about 0.2 v/v % to about 15 v/v % of the emulsifier; and about 0.2 v/v % to about 15 v/v % of the wetting agent.

9. The method according to any one of paragraphs 1-8, wherein the treatment fluid comprises: at least 90 v/v % of the base fluid; about 1.2 v/v % to about 5 v/v % of the emulsifier; and about 1.2 v/v % to about 5 v/v % of the wetting agent.

10. The method according to any one of paragraphs 1-9, wherein the treatment fluid comprises: at least 94 v/v % of the base fluid; about 1.5 v/v % to about 3 v/v % of the emulsifier; and about 1.5 v/v % to about 3 v/v % of the wetting agent.

11. The method according to any one of paragraphs 1-10, wherein the base fluid comprises diesel oil, kerosene, biodiesel, fuel oil, mineral oil, synthetic oil, crude oil, a vegetable oil, a fatty acid, an olefin, an organic ester, a linear paraffin, a branched paraffin, an acetal, salts thereof, or any combination thereof.

12. The method according to any one of paragraphs 1-11, wherein the emulsifier comprises a polyamide, an amido amine, a carboxylic acid, an ester or ether of carboxylic acid, a fatty acid, an ester or ether of fatty acid, a salt thereof, or any combination thereof.

13. The method according to any one of paragraphs 1-12, wherein the emulsifier comprises one or more tall oil fatty acids, an ester or ether of fatty acid of tall oil fatty acids, salts thereof, or any combination thereof.

14. The method according to any one of paragraphs 1-13, wherein the emulsifier has a hydrophilic:lipophilic balance of 9 or greater.

15. The method according to any one of paragraphs 1-14, wherein the wetting agent comprises a lecithin, an imidazoline, salts thereof, or any combination thereof.

16. The method according to any one of paragraphs 1-15, wherein the wetting agent has a hydrophilic:lipophilic balance ranging from about 6 to about 10.

17. The method according to any one of paragraphs 1-16, wherein the treatment fluid further comprises an additive selected from the group consisting of fluid loss agent, rheological modifier, viscosifier, lubricant agent, thinner, filtration control additive, pH adjusting agent, corrosion inhibitor, scale inhibitor, and any combination thereof.

18. The method according to any one of paragraphs 1-17, wherein preparing the treatment fluid comprises combining and mixing the base fluid, the emulsifier, and the wetting agent with a mixing system at the off-site location.

19. The method of paragraph 18, wherein the mixing system comprises a pump, a nozzle, or a combination thereof.

20. The method of paragraph 18 or 19, wherein the mixing system comprises a shearing pump, a centrifugal pump, a spray nozzle, an eductor nozzle, or any combination thereof.

21. The method according to any one of paragraphs 1-20, wherein each of the drilling fluid and the treated drilling fluid is a water-in-oil emulsion.

22. The method according to any one of paragraphs 1-21, wherein the treatment fluid is transported in a portable container from the off-site location to the drilling site.

23. The method of paragraph 22, wherein the portable container is transported by a truck, a railcar, a marine vessel, or any combination thereof.

While the foregoing is directed to implementations of the disclosure, other and further implementations may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A method for treating a drilling fluid within a wellbore, comprising:
preparing a treatment fluid at an off-site location, wherein the treatment fluid comprises a base fluid, an emulsifier, and a wetting agent;
transporting the treatment fluid from the off-site location to a drilling site containing the wellbore; and
adding the treatment fluid into the wellbore to combine with the drilling fluid and produce a treated drilling fluid.

2. The method of claim 1, wherein the treatment fluid is added to the wellbore while continuously drilling the wellbore.

3. The method of claim 1, wherein the treatment fluid is added to the wellbore at a rate from about 800 L/hr to about 13,000 L/hr.

4. The method of claim 3, wherein the treatment fluid is added to the wellbore at a rate from about 1,200 L/hr to about 8,000 L/hr.

5. The method of claim 1, wherein the treated drilling fluid comprises about 0.1 v/v % to about 90 v/v % of the treatment fluid.

6. The method of claim 1, wherein the treatment fluid comprises:
at least 94 v/v % of the base fluid;
about 1.5 v/v % to about 3 v/v % of the emulsifier; and
about 1.5 v/v % to about 3 v/v % of the wetting agent.

7. The method of claim 1, wherein the base fluid comprises diesel oil, kerosene, biodiesel, fuel oil, mineral oil, synthetic oil, crude oil, a vegetable oil, a fatty acid, an olefin, an organic ester, a linear paraffin, a branched paraffin, an acetal, salts thereof, or any combination thereof.

8. The method of claim 1, wherein the emulsifier comprises a polyamide, an amido amine, a carboxylic acid, an ester or ether of carboxylic acid, a fatty acid, an ester or ether of fatty acid, a salt thereof, or any combination thereof.

9. The method of claim 1, wherein the emulsifier comprises one or more tall oil fatty acids, an ester or ether of fatty acid of tall oil fatty acids, salts thereof, or any combination thereof.

10. The method of claim 1, wherein the emulsifier has a hydrophilic:lipophilic balance of 9 or greater.

11. The method of claim 1, wherein the wetting agent comprises a lecithin, an imidazoline, salts thereof, or any combination thereof.

12. The method of claim 1, wherein the wetting agent has a hydrophilic:lipophilic balance ranging from about 6 to about 10.

13. The method of claim 1, wherein the treatment fluid further comprises an additive selected from the group consisting of fluid loss agent, rheological modifier, viscosifier, lubricant agent, thinner, filtration control additive, pH adjusting agent, corrosion inhibitor, scale inhibitor, and any combination thereof.

14. The method of claim 1, wherein preparing the treatment fluid comprises combining and mixing the base fluid, the emulsifier, and the wetting agent with a mixing system at the off-site location.

15. The method of claim 14, wherein the mixing system comprises a shearing pump, a centrifugal pump, a spray nozzle, an eductor nozzle, or any combination thereof.

16. The method of claim 1, wherein each of the drilling fluid and the treated drilling fluid is a water-in-oil emulsion.

17. The method of claim 1, wherein the treatment fluid is transported in a portable container from the off-site location to the drilling site.

18. The method of claim 17, wherein the portable container is transported by a truck, a railcar, a marine vessel, or any combination thereof.

19. A method for treating a drilling fluid within a wellbore, comprising:
preparing a treatment fluid at an off-site location, wherein the treatment fluid comprises:
at least 85 v/v % of a base fluid, wherein the base fluid comprises diesel oil, kerosene, biodiesel, fuel oil, mineral oil, synthetic oil, crude oil, a vegetable oil, a fatty acid, an olefin, an organic ester, a linear paraffin, a branched paraffin, an acetal, salts thereof, or any combination thereof;
about 0.2 v/v % to about 15 v/v % of a emulsifier; and
about 0.2 v/v % to about 15 v/v % of a wetting agent;
transporting the treatment fluid from the off-site location to a drilling site containing the wellbore; and
adding the treatment fluid into the wellbore to combine with the drilling fluid.

20. A method for treating a drilling fluid within a wellbore, comprising:
combining and mixing a base fluid, an emulsifier, and a wetting agent with a pump at an off-site location to prepare a treatment fluid;
transporting the treatment fluid a portable container from the off-site location to a drilling site containing the wellbore; and
adding the treatment fluid at a rate from about 800 L/hr to about 13,000 L/hr into the wellbore to combine with the drilling fluid.
